(19) United States
(12) Patent Application Publication
(10) Pub. No.: US 2021/0040011 A1
(43) Pub. Date: Feb. 11, 2021

(54) Anti-Stacking

(71) Applicant: kevin Brian delahoussaye, las cruces, NM (US)

(72) Inventor: kevin Brian delahoussaye, las cruces, NM (US)

(21) Appl. No.: 16/517,590

(22) Filed: Aug. 5, 2019

(51) Int. Cl. C07B 61/00

(52) U.S. Cl. CPC C07B 61/00

(57) ABSTRACT

Meso compounds are compounds that have an internal plane of symmetry. This can be found and described in any organic chemistry textbook. Due to the existence of a meso compound an anti-meso compound exists. Stacking these molecules thus becomes easier. You can stack in a anti, meso-, anti, meso, anti, ect. The anti-symmetry displayed by the anti meso and the symmetry played by the meso will bond together with the appropriate constituents. A benzene ring with an appropriate constitute can be stacked with its meso and create a long polymer like compound that displays resonance and strong ionic or covalent bond depending on the group attached.

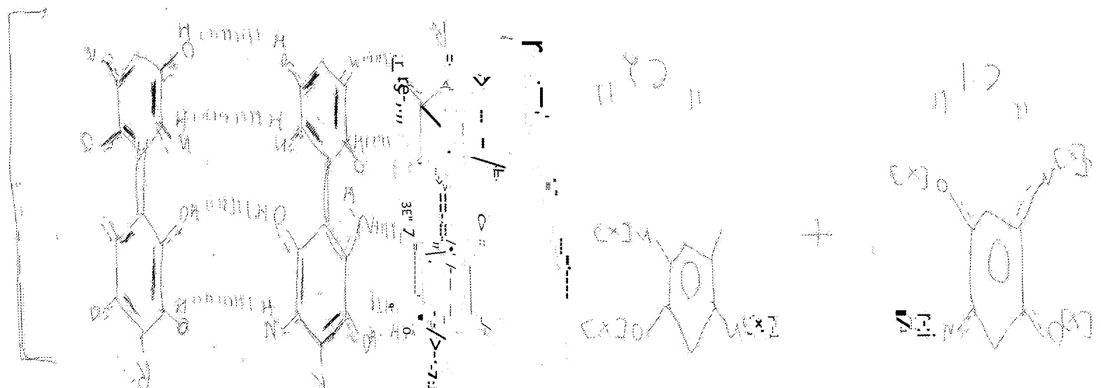

### BACKGROUND OF INVENTION

Meso compounds are compounds that have an internal plane of symmetry. This can be found and described in any organic chemistry textbook. Due to the existence of a meso compound an anti-meso compound exists. Stacking these molecules thus becomes easier. You can stack in an anti, meso-, anti, meso, anti, ect. The anti-symmetry displayed by the anti meso and the symmetry played by the meso will bond together with the appropriate constituents. A benzene ring with an appropriate constitute can be stacked with its meso and create a long polymer like compound that displays resonance and strong ionic or covalent bond depending on the group attached. You can now stack materials at a much greater strength and create new structures of great molecular strength.

### BRIEF SUMMARY OF INVENTION

Molecular stacking can be achieved with every meso compound. For example, A benzene ring with an appropriate constitute can be stacked with its meso and create a long polymer like compound that displays resonance and strong ionic or covalent bond depending on the group attached. You can now stack materials at a much greater strength and create new structures of great molecular strength.

### INTENDED USE

The intended use is to stack materials at a much greater strength and create new structures of great molecular strength. This novel technique will allow for many derivative discoveries and molecules.

### PICTURES

N/A Not Needed

A: Compounds of reciprocal or configuration can bond together form a long polymer like structure made out of molecular structures of opposite configurations.

B: A set of molecules with appropriate constitutes can be stacked with its opposite configured molecule and create a polymer like compound that displays resonance and strong ionic, hydrophobic, hydrophilic, attractive, and covalent properties depending on the group attached

C: Stacking these molecules with different constitutes leads to surfaces with chemicals properties that display chemical features such as resonance and strong ionic, hydrophobic, hydrophilic, attractive, and covalent properties which allow for different building materials.
